(19) United States
(12) Patent Application Publication
(10) Pub. No.: US 2011/0262015 A1
(43) Pub. Date: Oct. 27, 2011

(54) IMAGE PROCESSING APPARATUS, IMAGE PROCESSING METHOD, AND STORAGE MEDIUM

(75) Inventors: Ryo Ishikawa, Kawasaki-shi (JP); Kiyohide Satoh, Kawasaki-shi (JP); Takaaki Endo, Urayasu-shi (JP)

(73) Assignee: CANON KABUSHIKI KAISHA, Tokyo (JP)

(21) Appl. No.: 13/072,152

(22) Filed: Mar. 25, 2011

(30) Foreign Application Priority Data
Apr. 21, 2010 (JP) 2010-098127

(51) Int. Cl. G06K 9/00

(52) U.S. Cl. 382/128

(57) ABSTRACT

An image processing apparatus comprises: a deformation unit adapted to deform a first 3D image to a second 3D image; a calculation unit adapted to obtain a relation according to which rigid transformation is performed such that a region of interest in the first 3D image overlaps a region in the second 3D image that corresponds to the region of interest in the first 3D image; and an obtaining unit adapted to obtain, based on the relation, a cross section image of the region of interest in the second 3D image and a cross section image of the region of interest in the first 3D image that corresponds to the orientation of the cross section image in the second 3D image.

### BACKGROUND OF THE INVENTION

1. Field of the Invention

The present invention relates to an image processing apparatus, an image processing method and a storage medium for processing images captured by a medical image acquisition apparatus. Particularly, the present invention relates to an image processing apparatus, an image processing method and a storage medium for performing processing for associating a plurality of cross section images with each other.

2. Description of the Related Art

In the mammary gland medical field, there are cases where image diagnosis is performed in a procedure after the position of a lesion site in a breast is identified in an image captured by a magnetic resonance imaging apparatus (MRI apparatus), the state of the lesion site is observed by an ultrasound image diagnosis apparatus (ultrasound device). Here, according to a general capturing protocol employed in the mammary gland medical field, capturing by an MRI apparatus is often performed in a prone position (face-down position), and capturing by an ultrasound device is often performed in a supine position (face-up position). At this time, the doctor considers the deformation of the breast due to the difference in the capturing positions, and estimates the position of the lesion portion in the supine position based on the position of the lesion portion identified on a prone position MRI image, and captures an image at the estimated position of the lesion portion using an ultrasound device.

However, if the breast is deformed to a very large degree due to the difference in the capturing positions, and the position of the lesion portion in the supine position estimated by the doctor may sometimes greatly differ from the actual position thereof.

It is possible to address this issue by using a known technique in which a virtual supine position MRI image is generated by performing deformation processing on a prone position MRI image. It is possible to calculate the position of the lesion portion in the virtual supine position MRI image based on information of the deformation that occurs due to a change from the prone position to the supine position. Alternatively, the position of the lesion portion in that image can be directly obtained by visually interpreting the generated virtual supine position MRI image. If this deformation processing is performed with high accuracy, the actual position of lesion portion in the supine position will be near the lesion portion in the virtual supine position MRI image.

Here, there is a case where there is a desire to display cross section images of the prone position MRI image and the supine position MRI image corresponding to each other, in addition to calculating the position of the lesion portion in the supine position MRI image that corresponds to the position of the lesion portion in the prone position MRI image. For example, there is a case in which the doctor desires to examine the condition of the lesion portion in detail based on the original image, by displaying a cross section image of the prone position MRI image before deformation, the cross section corresponding to the cross section containing the lesion portion designated in the virtual supine position MRI image after deformation. In contrast, there is a case in which the doctor desires to confirm what a cross section of the prone position MRI image before deformation will look like in a virtual supine position MRI image after deformation.

For example, Japanese Patent Laid-Open No. 2008-073305 discloses a technique in which one of two 3D images in different deformation states is deformed and subjected to shaping, and cross sections of the two 3D images of a common portion are displayed side by side. Also, Japanese Patent Laid-Open No. 2009-090120 discloses a technique in which an image slice in one image data set that corresponds to an image slice designated in another image data set is identified, and both image slices are displayed aligned in the same plane.

However, in the technique disclosed in Japanese Patent Laid-Open No. 2008-073305, common cross sections are respectively extracted after deforming a current 3D image and a past 3D image thereof into the same shape, and therefore there is an issue that the images of the cross sections corresponding to each other cannot be displayed while maintaining their mutually different shapes. In addition, in the technique of Japanese Patent Laid-Open No. 2009-090120, image slices are simply selected from among image data sets, and thus except for special cases, there is an issue that with respect to a cross section image designated in one of data set, it is impossible to generate an appropriate cross section image in the one data set that corresponds to a cross section image designated in the other data set.

In view of the above-described issues, the present invention enables generating corresponding cross section images in a plurality of 3D images.

### SUMMARY OF THE INVENTION

According to one aspect of the present invention, there is provided an image processing apparatus comprising: a deformation unit adapted to deform a first 3D image to a second 3D image; a calculation unit adapted to obtain a relation according to which rigid transformation is performed such that a region of interest in the first 3D image overlaps a region in the second 3D image that corresponds to the region of interest in the first 3D image; and an obtaining unit adapted to obtain, based on the relation, a cross section image of the region of interest in the second 3D image and a cross section image of the region of interest in the first 3D image that corresponds to the orientation of the cross section image in the second 3D image.

According to another aspect of the present invention, there is provided a method for processing an image comprising: deforming a first 3D image into a second 3D image; obtaining a relation according to which rigid transformation is performed such that a region of interest in the first 3D image overlaps a region in the second 3D image that corresponds to the region of interest in the first 3D image; and obtaining, based on the relation, a cross section image of the region of interest in the second 3D image and a cross section image of the region of interest in the first 3D image that corresponds to the orientation of the cross section image in the second 3D image.

Further features of the present invention will be apparent from the following description of exemplary embodiments with reference to the attached drawings.

### BRIEF DESCRIPTION OF THE DRAWINGS

FIG. 1A is a diagram illustrating a functional configuration of an image processing apparatus according to a first embodiment.

FIG. 1B is a diagram illustrating a functional configuration of a relation calculation unit according to the first embodiment.

FIG. 2 is a diagram illustrating a basic configuration of a computer which realizes units of the image processing apparatus with software.

FIG. 3A is a flowchart illustrating an overall processing procedure according to the first embodiment.

FIG. 3B is a flowchart illustrating a processing procedure for relation calculation according to the first embodiment.

FIG. 4A is a diagram illustrating a method for obtaining representative points according to the first embodiment.

FIG. 4B is a diagram illustrating a method for generating a display image according to the first embodiment.

FIG. 5 is a diagram illustrating a functional configuration of an image processing apparatus according to a second embodiment.

FIG. 6A is a flowchart illustrating an overall processing procedure according to the second embodiment.

FIG. 6B is a flowchart illustrating a processing procedure for relation calculation according to the second embodiment.

FIG. 7 is a diagram illustrating a method for generating a display image according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

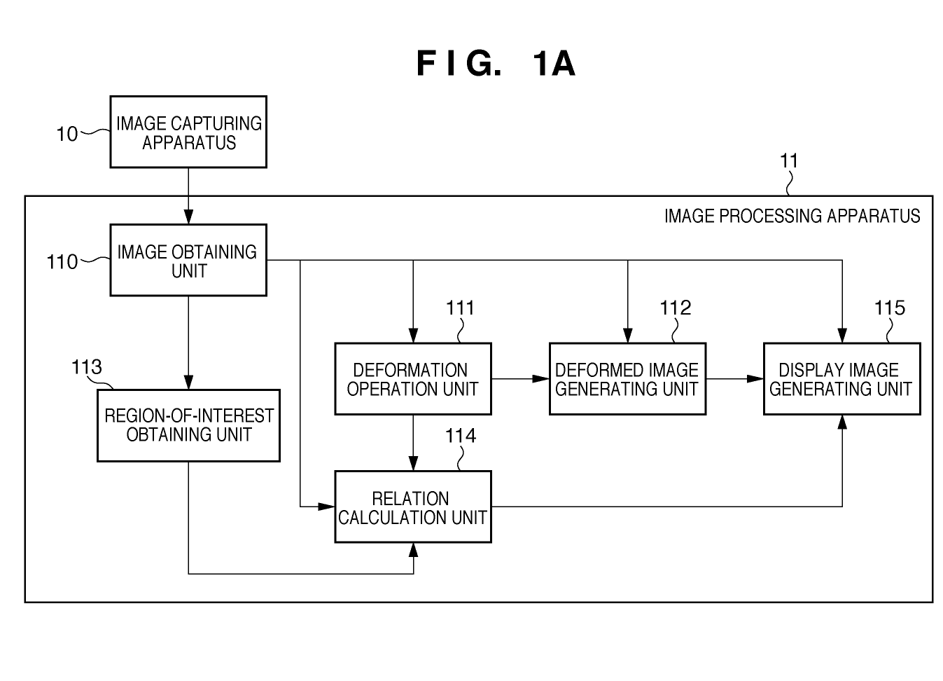

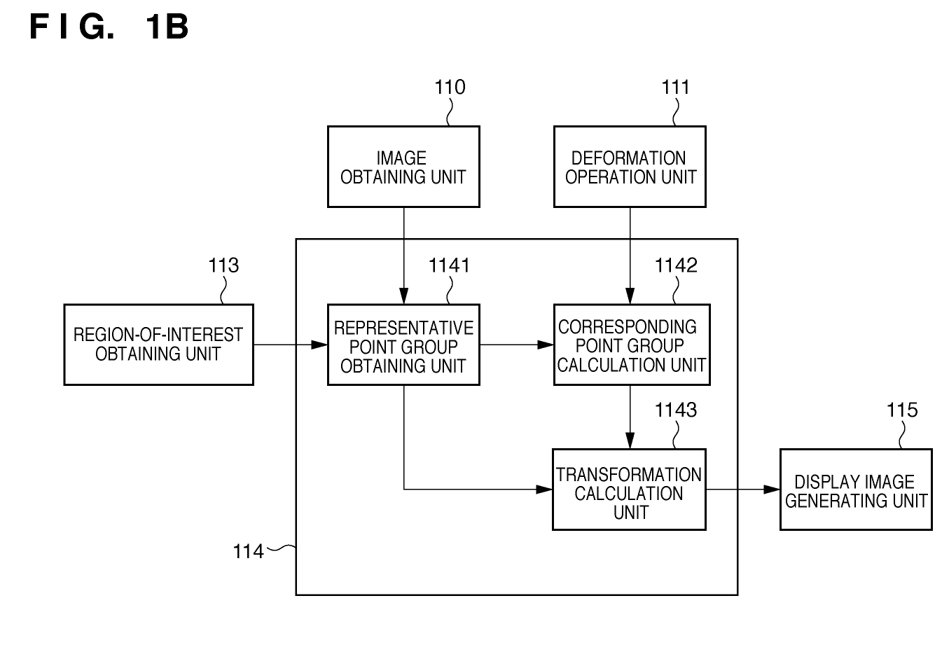

An image processing apparatus according to the present embodiment virtually generates a 3D image in a second deformation state by performing deformation on a 3D image captured in a first deformation state. Then, cross section images containing a region of interest are generated from the respective 3D images, and the generated images are displayed side by side. Note that in the present embodiment, a human breast is the main target object. The case in which an MRI image of a breast is obtained and a lesion portion in the breast serves as a region of interest will be described as an example. Also in the present embodiment, for example, the first deformation state is a state in which a subject is in a face-down state (prone position) with respect to the direction of gravitational force, and the second deformation state is a state in which a subject is in a face-up state (supine position) with respect to the direction of gravitational force. The first deformation state is a state in which a first position and orientation are maintained, and the second deformation state is a state in which a second position and orientation are maintained. Hereinafter, an image processing apparatus according to the present embodiment will be described with reference to FIG. 1A. As shown in FIG. 1A, an image processing apparatus 11 of the present embodiment is connected to an image capturing apparatus 10. The image capturing apparatus 10 is, for example, an MRI apparatus and captures an image of a breast serving as a target object in the prone position (first deformation state) to obtain a first 3D image (volume data) thereof.

The image processing apparatus 11 includes an image obtaining unit 110, a deformation operation unit 111, a deformation image generating unit 112, a region-of-interest obtaining unit 113, a relation calculation unit 114 and a display image generating unit 115. The image obtaining unit 110 obtains a first 3D image from the image capturing apparatus 10 and outputs the first 3D image to the deformation operation unit 111, deformation image generating unit 112, region-of-interest obtaining unit 113, relation calculation unit 114 and display image generating unit 115.

The deformation operation unit 111 calculates a deformation amount occurring in the target object due to the change from the prone position (first deformation state) to the supine position (second deformation state), and outputs the calculation result to the deformation image generating unit 112 and the relation calculation unit 114.

The deformation image generating unit 112 performs deformation processing on the first 3D image (MRI image in the prone position) obtained by the image obtaining unit 110 based on the deformation amount calculated by the deformation operation unit 111, and generates a second 3D image (virtual MRI image in the supine position). Then, the deformation image generating unit 112 outputs the second 3D image to the display image generating unit 115.

The region-of-interest obtaining unit 113 obtains a region of interest such as a lesion portion in the first 3D image obtained by the image obtaining unit 110, and outputs the region of interest to the relation calculation unit 114.

The relation calculation unit 114 obtains a rigid transformation that approximates a change in the position and orientation of the region of interest due to deformation, based on the first 3D image obtained by the image obtaining unit 110, the region of interest obtained by the region-of-interest obtaining unit 113, and the deformation amount of the target object calculated by the deformation operation unit 111. Note that the configuration of the relation calculation unit 114 is the most characteristic configuration in the present embodiment, and therefore will be described in detail below with reference to the block diagram shown in FIG. 1B.

The display image generating unit 115 generates a display image from the first 3D image obtained by the image obtaining unit 110 and the second 3D image generated by the deformation image generating unit 112, based on the rigid transformation calculated by the relation calculation unit 114. The generated display image is displayed by a display unit not shown in the drawings.

Next, the internal configuration of the relation calculation unit 114 will be described with reference to FIG. 1B. The relation calculation unit 114 includes a representative point group obtaining unit 1141, a corresponding point group calculation unit 1142 and a transformation calculation unit 1143.

The representative point group obtaining unit 1141 obtains a representative point group based on the region of interest obtained by the region-of-interest obtaining unit 113 and the first 3D image obtained by the image obtaining unit 110, and outputs the representative point group to the corresponding point group calculation unit 1142 and the transformation calculation unit 1143. Here, the representative point group is a group of coordinates of characteristic positions that clearly indicates the shape of a lesion portion or the like near the region of interest, and is obtained by processing the first 3D image.

The corresponding point group calculation unit 1142 calculates a corresponding point group obtained by shifting the coordinates of the points in the representative point group obtained by the representative point group obtaining unit 1141, based on the deformation amount occurring in the target object calculated by the deformation operation unit 111, and outputs the corresponding point group to the transformation calculation unit 1143.

The transformation calculation unit 1143 calculates a rigid transformation parameter that approximates the relation between the representative point group obtained by the representative point group obtaining unit 1141 and the corresponding point group calculated by the corresponding point group calculation unit 1142, based on the positional relation between the positions thereof, and outputs the rigid transformation parameter to the display image generating unit 115. Note that at least part of the units of the image processing apparatus 11 shown in FIG. 1A may be realized as a separate device. Alternatively, each unit may be realized as software that realizes the function thereof as a result of being installed on one or a plurality of computers and executed by the CPU of the computers. In the present embodiment, the respective units are realized by software and installed on the same computer.

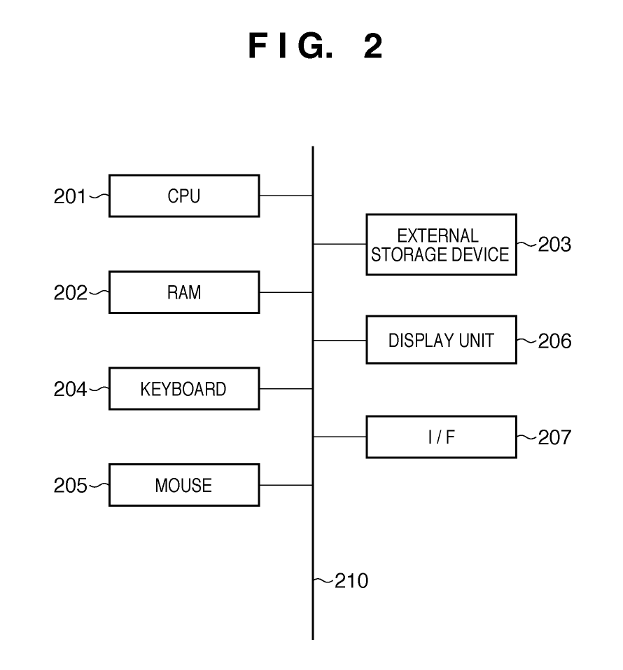

With reference to FIG. 2, a basic configuration of a computer which realizes functions of the units shown in FIGS. 1A and 1B by executing software will be described. A CPU 201 controls the entire computer using programs and data stored in a RAM 202. Also, the functions of the units are realized by controlling execution of software. The RAM 202 includes an area for temporarily storing programs and data loaded from an external storage device 203, and a work area for use by the CPU 201 for performing various types of processing. The external storage device 203 is a high-capacity information storage device such as an HDD, and stores an OS (operating system), programs executed by the CPU 201, data and the like. A keyboard 204 and a mouse 205 are input devices. Various instructions from the user can be input by using these input devices. A display unit 206 is configured by a liquid crystal display or the like, and displays images and the like generated by the display image generating unit 115. The display unit 206 also displays messages, a GUI and the like. An I/F 207 is an interface, and is configured by an Ethernet (registered trademark) port for inputting/outputting various types of information, and the like. Various types of input data are loaded via the I/F 207 to the RAM 202. Part of the functions of the image obtaining unit 110 are realized by the I/F 207. The constituent elements described above are interconnected by a bus 210.

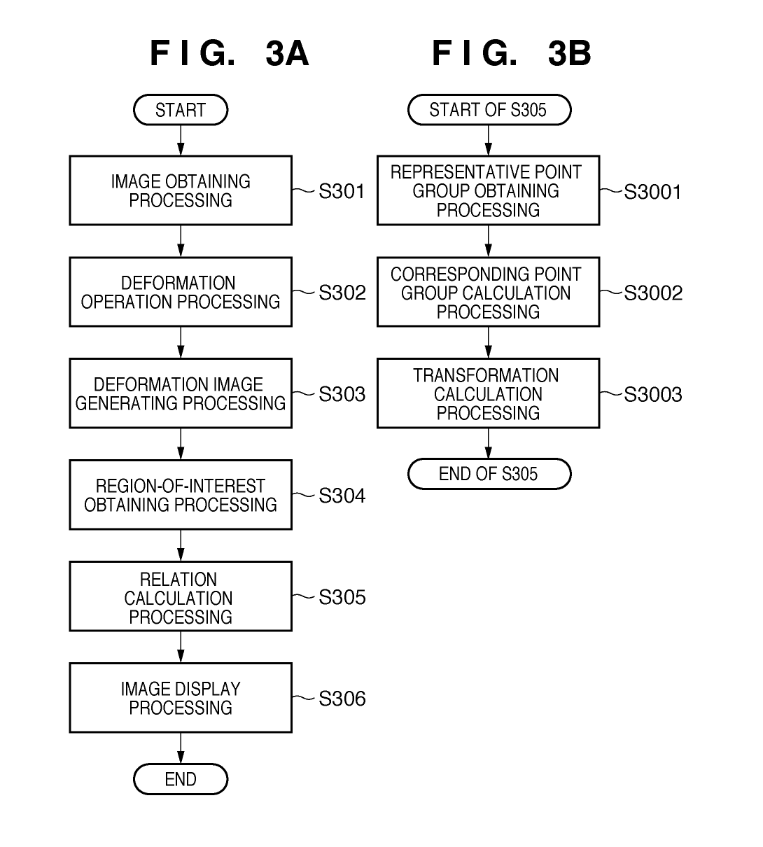

With reference to FIG. 3A, the flowchart illustrating an overall processing procedure performed by the image processing apparatus 11 will be described. Note that each process shown in the flowchart is realized by the CPU 201 executing programs for realizing the functions of the units. Note that before executing the following processing, program code in accordance with the flowchart is assumed to have been loaded to the RAM 202 from the external storage device 203, for example.

In step S301, the image obtaining unit 110 obtains a first 3D image (volume data) input to the image processing apparatus 11. Note that in the description below, the coordinate system defined for describing the first 3D image is referred to as a first reference coordinate system.

In step S302, the deformation operation unit 111 that functions as a shift calculation unit obtains the shape of a breast in the prone position captured in the first 3D image. Then, the deformation operation unit 111 calculates deformation (deformation field representing a shift amount) that will occur in the target object due to the difference in the relative directions of the gravitational force when the body position has changed from the prone position to the supine position. This deformation is calculated as a displacement field (3D vector field) in the first reference coordinate system, and expressed as T(x, y, z). This processing can be executed by, for example, a generally well-known method such as physical deformation simulation by the finite element method. Note that deformation that will occur in the target object due to a change in the direction of any external force other than the gravitational force, as in the case in which the direction of an external force applied to a target object is changed, may be calculated. For example, an operation for sending/receiving ultrasonic signals from a probe is necessary when a tomographic image of the target object is captured. In such a case, the target object is deformed as a result of the probe and the target object coming into contact with each other.

In step S303, the deformation image generating unit 112 that functions as a first generating unit generates a second 3D image by performing deformation processing on the first 3D image, based on the first 3D image obtained in the foregoing step and a displacement field T(x, y, z). Here, the second 3D image can be regarded as a virtual MRI image corresponding to an image obtained by capturing an image of a breast serving as the target object in the supine position. Note that in the following description, the coordinate system defined for describing the second 3D image will be referred to as a second reference coordinate system.

In step S304, the region-of-interest obtaining unit 113 obtains a region of interest (characteristic region) in the first 3D image. For example, the region-of-interest obtaining unit 113 automatically detects the region of interest (e.g., a region suspected to be a lesion portion) by processing the first 3D image. Also, the region-of-interest obtaining unit 113 obtains information indicating the range of the detected region (e.g., volume data in which voxels (a voxel is a unit three-dimensional element) representing the region are labeled), or the coordinate values of the center of gravity of the detected region as the center position X_{sc}=(x_{sc}, y_{sc}, z_{sc}) of the region of interest. Note that obtainment of the region of interest is not limited to automatic detection. For example, the region of interest may be obtained by user input through the mouse 205, keyboard 204, etc. For example, the VOI (volume-of-interest) in the first 3D image may be input by the user as the region of interest, or the three-dimensional coordinate X, of one point representing the center position of the region of interest may be input by the user.

In step S305, the relation calculation unit 114 obtains a rigid transformation that approximates a change in the position and orientation of the region of interest obtained in step S304 based on the displacement field obtained in step S302. The processing for obtaining a rigid transformation in step S305 is the most characteristic processing of the present embodiment, and thus is described below in detail with reference to the flowchart shown in FIG. 3B.

In step S3001 in FIG. 3B, the representative point group obtaining unit 1141 shown in FIG. 1B obtains the positions of a plurality of representative points (representative point group positions) to be used in the subsequent processing from within a predetermined range based on the region of interest obtained in step S304.

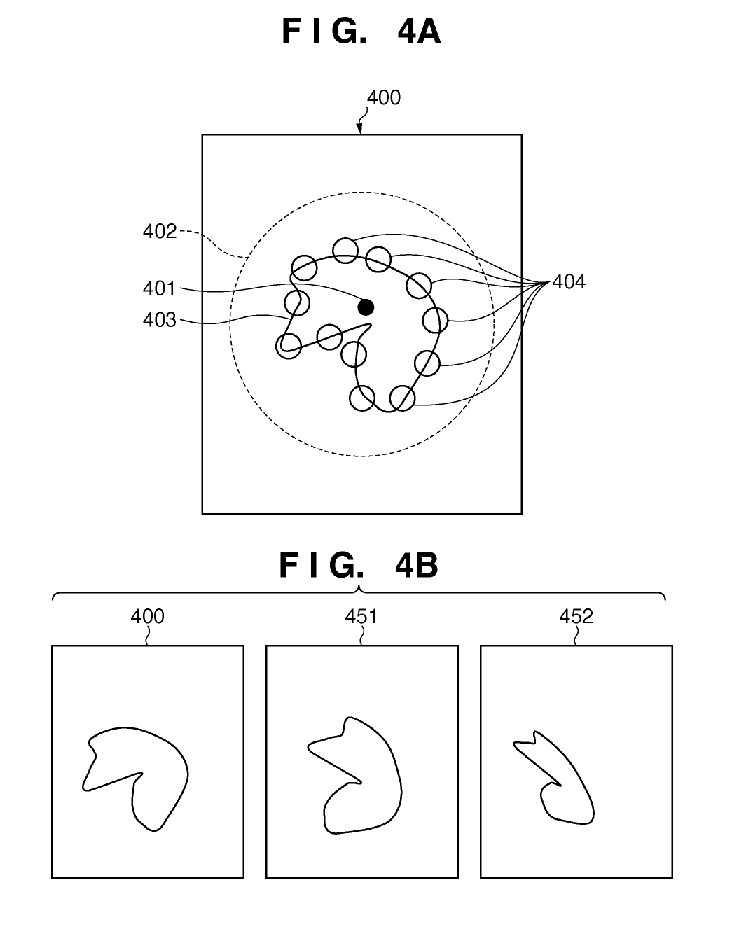

This processing is described below with reference to FIGS. 4A and 4B. Note that although a two-dimensional image is used for description in FIGS. 4A and 4B, the actual processing handles 3D images (volume data). In the examples of FIGS. 4A and 4B, it is assumed that in step S304 the region-of-interest obtaining unit 113 obtained a center position 401 of the region of interest in a first 3D image 400.

At this time, the representative point group obtaining unit 1141 first sets, as a peripheral region 402, a predetermined range centered about the center position 401 of the region of interest (e.g., within a sphere having a predetermined radius r centered about the center position 401). Here, an object of interest 403 such as a lesion portion is assumed to be included in the peripheral region 402. Note that in step S304, in the case where the information representing the range of the region of interest has already been obtained by image processing, the range of the peripheral region 402 may be set according to the range of the detected region of interest. Also, in the case where the region of interest has been obtained in step S304 as a result of the user having inputted the VOI, the range of the peripheral region 402 may be set according to the range of the VOI. That is, the detected region or designated VOI may be used as the peripheral region 402 as is, or a smallest sphere including the detected region or designated VOI may be used as the peripheral region 402. Also, with the use of an unshown UI (user interface), the user may designate the radius r of the sphere representing the peripheral region 402.

Next, the representative point group obtaining unit 1141 obtains, as a plurality of points that characteristically represent the form of the object of interest 403 such as a lesion portion, a representative point group 404 by processing the first 3D image within the range of the peripheral region 402. In this processing, for example, the representative point group 404 is obtained by performing edge detection processing or the like based on pixel values on each voxel within the peripheral region 402, and selecting voxels having edge intensities greater than or equal to a predetermined threshold.

Lastly, the representative point group obtaining unit 1141 that also functions as a weighted coefficient calculation unit calculates weighted coefficients of the selected points according to the edge intensities thereof, and adds the information of the weighted coefficients to the representative point group 404. By the above-described processing, the representative point group obtaining unit 1141 obtains the positions Xₛₙ=(xₛₙ, yₛₙ, zₛₙ) (n=1 to N, N being the number of the representative points) of the representative point group 404 and the weighted coefficients Wₛₙ thereof.

Note that in the case where the user selected a method for obtaining the representative point group by using an unshown UI, the representative point group obtaining unit 1141 obtains the representative point group by the selected method for obtaining the representative point group. For example, a method can be selected in which the contour of the object of interest 403 such as a lesion portion is obtained by image processing, points are disposed on the contour at equal intervals and nearest voxels to the respective points are obtained as the representative point group 404. Also, a method can be selected in which grid points that equally divide a three-dimensional space within the peripheral region 402 are obtained as the representative point group 404. Note that the method for selecting the representative point group 404 is not limited to the above examples.

In the case where the user designated a method for calculating the weighted coefficient Wₛₙ by using an unshown UI, the representative point group obtaining unit 1141 calculates the weighted coefficient by the designated calculation method. For example, a method can be selected in which the weighted coefficient of the representative point is calculated based on a distance dₛₙ from the center position 401 of the region of interest obtained in step S304 (e.g., the center of gravity of the region of interest, or the center of gravity of the peripheral region 402). For example, the weighted coefficient may be obtained with the use of a distance function in which when the distance dₛₙ is equal to the above-described radius r, the weighted coefficient is set to zero, and when the distance dₛₙ is zero, the weighted coefficient is set to one (e.g. Wₛₙ=(dₛₙ−r)/r). In such a case, the weighted coefficient of each representative point is calculated as a value that is larger as the distance from the center of gravity of the characteristic region (or peripheral region) is shorter, and is smaller as the distance is longer. In addition, a configuration may be adopted in which it is possible to select a method in which the weighted coefficient is obtained based on both the edge intensity and the distance dₛₙ. Note that the method for calculating the weighted coefficient Wₛₙ is not limited to the above examples.

Next, in step S3002, the corresponding point group calculation unit 1142 that functions as a corresponding point group obtaining unit shifts the positions of the points in the representative point group 404 calculated in step S3001, based on the displacement field T(x, y, z) calculated in step S302. In this manner, it is possible to calculate the positions of the point group in the second 3D image (corresponding point group positions) that correspond to the positions of the representative point group in the first 3D image. Specifically, for example, a displacement field T (xₛₙ, yₛₙ, zₛₙ) at the position Xₛₙ in the representative point group 404 is added to the position Xₛₙ of the representative point group 404, thereby calculating the position X_{dn} (n=1 to N) of the corresponding point in the second 3D image. Note that since the deformation state differs between the first 3D image and the second 3D image, the positional relationship in the corresponding point group is different from that in representative point group.

Lastly, in step S3003, the transformation calculation unit 1143 calculates a rigid transformation matrix that approximates the relation between these point groups, based on the positions Xₛₙ of the representative point group 404 and the positions X_{dn} of the corresponding point group. Specifically, the transformation calculation unit 1143 calculates a matrix T_{rigid} of the rigid transformation shown in Equation 1 that minimizes a sum e of errors. In other words, a value obtained by multiplying a norm of a difference between the corresponding point and a product of the transformation matrix and the representative point by a weighted coefficient is obtained for each representative point, a sum total e of such values is calculated, and a transformation matrix T_{rigid} which produces the smallest sum total e is calculated.

e=Σ_{n=1˜N}(Wₛₙ∥X_{dn}−T_{rigid}Xₛₙ∥) (1) Equation 1

In Equation 1, errors are weighted and evaluated according to information Wₛₙ of the weighted coefficients applied to the corresponding point group. Note that since the matrix T_{rigid} can be calculated by a known method using singular value decomposition or the like, the calculation method thereof will not be described.

This completes the description of the processing of step S305.

Returning to FIG. 3A, in step S306, the display image generating unit 115 generates a display image. The processing of this step is described below with reference to FIG. 4B. Note that FIG. 4B displays a two-dimensional image, which is originally a 3D image.

Firstly, the display image generating unit 115 generates a third 3D image 451 by performing rigid transformation based on the relation calculated in step S305 on the first 3D image 400 obtained in step S301 (secondary generation). Since a known method can be used for performing rigid transformation of 3D images, the method is not described here. This processing involves rigid transformation of the first 3D image such that the position and orientation of the region of interest in the third 3D image 451 substantially match those of the region of interest in a second 3D image 452.

Then, two-dimensional images (display images) for displaying the third 3D image and the second 3D image are generated. Various methods for generating two-dimensional images for displaying 3D images are known. For example, a method is known in which a plane is set for the reference coordinate system for a 3D image, and the cross section image of the 3D image taken along that plane is obtained as a two-dimensional image. With this method, for example, a plane for generating a cross section is obtained by input processing performed by the user, the reference coordinate systems for the third 3D image and the second 3D image are regarded as the same, and the cross section images of the second and third 3D images taken along that plane are obtained. The plane is obtained so as to include the center position (or the position of the center of gravity defined from the range of the region of interest) of the region of interest obtained in step S304. Accordingly, cross section images that each contain a region of interest such as a lesion portion in the 3D images can be obtained, the positions and orientations of the regions of interest in the cross section images substantially matching each other. Lastly, the image processing apparatus 11 displays the generated display images on the display unit 206.

As described above, the image processing apparatus according to the present embodiment obtains, based on 3D images in different deformation states, cross section images in which the positions and orientations of the regions of interest such as lesion portions that are respectively captured in the 3D images substantially match, and displays these images side by side. Accordingly, comparison of the cross sections of the region of interest such as a lesion portion before and after deformation is easier.

### Second Embodiment

Transformation calculation processing performed in the transformation calculation unit 1143 may be processing other than the processing described above. For example, the corresponding point of the center position 401 of the region of interest may be calculated using a method similar to that in step S3002, and a parallel translation component of the rigid transformation may be determined such that these two points match. Specifically, the displacement field T(x_{sc}, y_{sc}, z_{sc}) at the center position 401 (coordinate X_{sc}) of the region of interest may be used as the parallel translation component of the rigid transformation. In this case, when calculating the matrix T_{rigid} shown in Equation 1 that minimizes the sum e of errors, a configuration is possible in which the parallel translation component of T_{rigid} is fixed to the above value, and only the rotation component is obtained as an unknown parameter. In this manner, the center positions of the region of interest of the third 3D image and the second 3D image can be matched with each other.

In the first embodiment, the case in which an MRI apparatus is used as the image capturing apparatus 10 is described as an example, but the present invention is not limited thereto. For example, an x-ray computed tomography (CT) scanner, photoacoustic tomography scanner, optical coherence tomography (OCT) apparatus, positron-emission tomography (PET)/single-photon emission computerized tomography (SPECT) apparatus, or 3D ultrasound device can be used. Also, the target object is not limited to a human breast, and may be any arbitrary target object.

In the first embodiment, in the image display processing in step S306, cross section images of the third 3D image and the second 3D image are generated based on the cross section designated by the user. However, as long as the cross section images are generated from 3D images based on a designated cross section, the cross section image to be generated need not be an image generated by imaging the voxel values on the designated cross section. For example, the cross section image may be a highest intensity projection which is obtained by setting a predetermined range in the normal direction centered about the cross section, and obtaining the highest values of the voxel values in the normal direction within that range with respect to the points on the cross section. In the present invention, an image as described above that is generated in relation to the designated cross section is also included as a “cross section image” in broader meaning. In addition, the third 3D image and the second 3D image may be respectively displayed by another volume rendering method or the like, after setting the same viewpoint position or the like for the second and third 3D images.

### Third Embodiment

With the first and second embodiments, the case is described in which a rigid transformation that approximates a change in the position and orientation of the region of interest in the 3D images before and after transformation is calculated in advance. However, the present invention is not limited to this. An image processing apparatus of the present embodiment dynamically changes the method for calculating a rigid transformation depending on the position and orientation of the designated cross section. Only portions of the image processing apparatus of the present embodiment that are different from the first and second embodiments are described below.

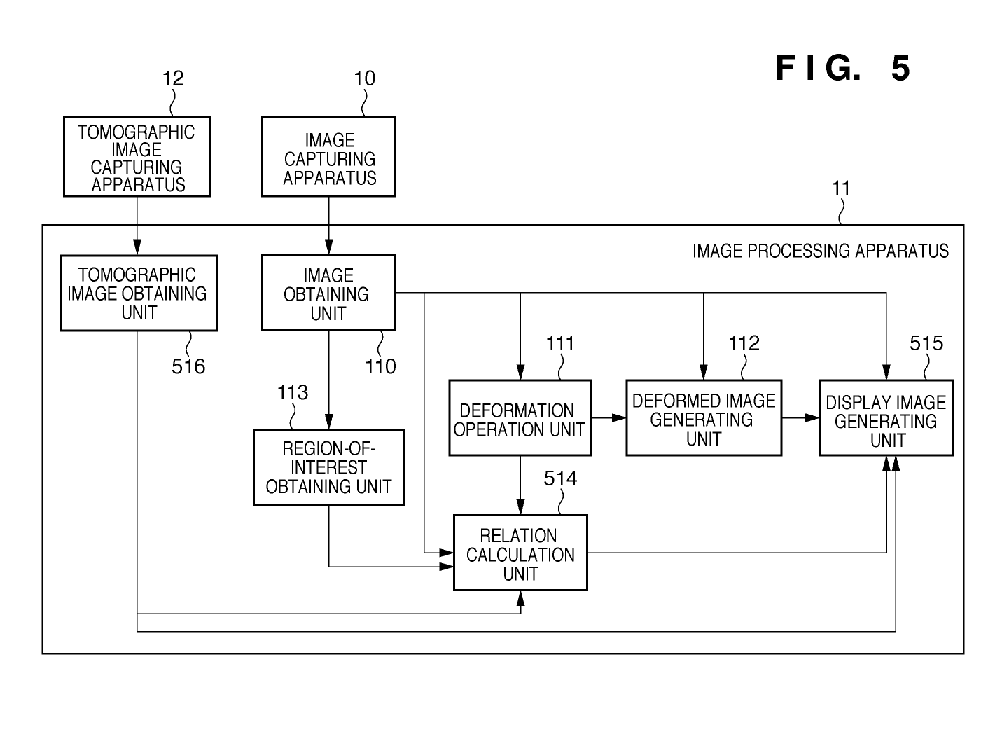

A configuration of the image processing apparatus of the present embodiment is described below with reference to FIG. 5. Note that the same elements as those in FIG. 1A are assigned the same reference numerals, and are not described here. As shown in FIG. 5, an image processing apparatus 11 of the present embodiment is connected to the image capturing apparatus 10 and also to a tomographic image capturing apparatus 12, and additionally includes a tomographic image obtaining unit 516 for obtaining information from the tomographic image capturing apparatus 12, which are main differences from FIG. 1A. Furthermore, processing executed by a relation calculation unit 514 and a display image generating unit 515 is different from that executed by the relation calculation unit 114 and the display image generating unit 115 of the first embodiment.

An ultrasound device serving as the tomographic image capturing apparatus 12 captures tomographic images of the target object in the supine position by sending/receiving ultrasonic signals from a probe. Furthermore, it is assumed that the position and orientation of tomographic images are obtained in a coordinate system that uses a position and orientation sensor as a reference (hereinafter referred to as a “sensor coordinate system”), by measuring the position and orientation of the probe during capturing by the position and orientation sensor. Then, tomographic images and accompanying information thereof, namely, the position and orientation thereof, are sequentially output to the image processing apparatus 11. Here, the position and orientation sensor may have any configuration as long as it can measure the position and orientation of the probe.

The tomographic image obtaining unit 516 sequentially obtains tomographic images and the positions and orientations thereof as accompanying information input from the tomographic image capturing apparatus 12 to the image processing apparatus 11, and outputs the tomographic images and the positions and orientations to the relation calculation unit 514 and the display image generating unit 515. Here, the tomographic image obtaining unit 516 transforms the position and orientation in the sensor coordinate system to those in the second reference coordinate system, and outputs them to the units.

The relation calculation unit 514 obtains a rigid transformation that performs compensation between the first reference coordinate system and the second reference coordinate system, based on input information similar to that in the first embodiment, and the tomographic image obtained by the tomographic image obtaining unit 516. Note that although the configuration of the relation calculation unit 514 is similar to that shown in FIG. 1B in the first embodiment, processing performed by the representative point group obtaining unit 1141 and the corresponding point group calculation unit 1142 is different from that of the first embodiment. The representative point group obtaining unit obtains the position of the region of interest obtained by the region-of-interest obtaining unit 113, the first 3D image obtained by the image obtaining unit 110, and the position and orientation as accompanying information of the tomographic image obtained by the tomographic image obtaining unit 516. Then, the representative point group obtaining unit obtains a representative point group based on these, and outputs the representative point group to the corresponding point group calculation unit and a transformation calculation unit. Note that in the present embodiment, the representative point group is obtained as a coordinate group that is arranged on the cross section representing a tomographic image, based on the position of the region of interest, the position and orientation of the tomographic image and the first 3D image.

The display image generating unit 515 generates a display image from the first 3D image obtained by the image obtaining unit 110, the second 3D image generated by the deformation image generating unit 112 and the tomographic image obtained by the tomographic image obtaining unit 516, based on the rigid transformation calculated by the relation calculation unit 514. Then, the generated display image is displayed on a display unit not shown in the drawings.

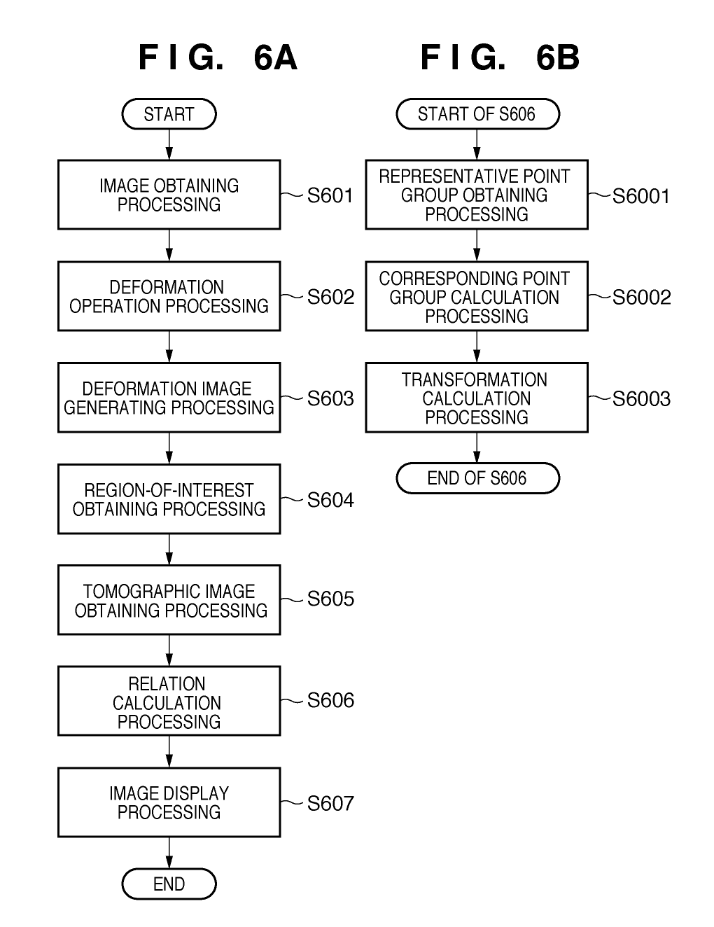

The following describes the overall processing procedure performed by the image processing apparatus 11 with reference to the flowchart of FIG. 6A.

Processing in steps S601 to S604 is performed in a similar manner to that in steps S301 to S304 of the first embodiment, and thus is not described here.

In step S605, the tomographic image obtaining unit 516 obtains a tomographic image input to the image processing apparatus 11. Then, the position and orientation in the sensor coordinate system as accompanying information of the tomographic image are transformed to a position and orientation in the second reference coordinate system. This transformation can be performed in the following procedure, for example. First, characteristic sites such as a mammary gland structure that are captured in both the tomographic image and the second 3D image are associated with each other automatically or by user input. Next, based on the relation between these positions, a rigid transformation from the sensor coordinate system to the second reference coordinate system is obtained. Then, with the rigid transformation, the position and orientation in the sensor coordinate system are transformed to the position and orientation in the second reference coordinate system. In addition, the position and orientation in the second reference coordinate system obtained by the transformation are newly set as accompanying information of the tomographic image.

In step S606, the relation calculation unit 514 executes the following processing. Specifically, the relation calculation unit 514 obtains a rigid transformation that performs compensation between the first reference coordinate system and the second reference coordinate system based on the displacement field obtained in step S602, the position of the region of interest obtained in step S604, and the position and orientation of the tomographic image obtained in step S605. The processing of step S606 is the most characteristic processing of the present embodiment, and thus is described below in further detail with reference to the flowchart shown in FIG. 6B.

In step S6001, the relation calculation unit 514 performs the processing described below with the representative point group obtaining unit S141. First, the position of the region of interest obtained in step S604 is shifted based on the displacement field T(x, y, z) calculated in step S602, thereby calculating the position of the region of interest after deformation. Next, a distance dₚ between the position of the region of interest after deformation and the plane representing the tomographic image obtained in step S605 is obtained. Here, the plane representing the tomographic image is obtained from the position and orientation of the tomographic image, and the distance dₚ is calculated as the length of a perpendicular line to the plane representing the tomographic image from the position of the region of interest after deformation relative to the plane.

When the distance dₚ is larger than a predetermined threshold, the following processing is performed. Firstly, the two-dimensional region representing the capturing range of the tomographic image in the plane is divided into a two-dimensional equal grid. Then, the points in the representative point group are arranged at the intersections of the grid. At this time, edge detection processing is performed on the cross section image of the second 3D image or the tomographic image at each arranged point, the weighted coefficients for the points are calculated according to the corresponding edge intensities, and the information of the weighted coefficients is added to the representative point group. Note that the cross section image of the second 3D image is generated from the second 3D image by using the plane representing the tomographic image obtained in step S605 as the cross section.

In contrast, when the distance dₚ is smaller than the predetermined threshold, the following processing is performed. Firstly, a two-dimensional region (hereinafter referred to as a “peripheral region”) is set in a predetermined range in the plane centered about an intersection xₚ of the perpendicular line and the plane. Then, edge detection processing is performed on the cross section image of the second 3D image or the tomographic image in the two-dimensional peripheral region, and points having edge intensities greater than or equal to a predetermined threshold are selected as a representative point group. Note that the method for obtaining the representative point group is not limited to the above method, and the representative point group may be obtained by obtaining the contour of the object of interest such as a lesion portion from the result of edge detection processing, and arranging points on the contour at equal intervals. Lastly, weighted coefficients of the selected points are calculated according to the edge intensities thereof, and the information of the weighted coefficients is added to the representative point group.

By the processing described above, the representative point group obtaining unit S141 obtains the positions Xₛₙ=(xₛₙ, yₛₙ, zₛₙ) (n=1 to N, N being the number of representative points) of the representative point group and the weighted coefficients Wₛₙ thereof.

Also, in the case where the user designates a method for obtaining the representative point group by using an unshown UI, the representative point group obtaining unit 5141 obtains the representative point group by the designated method. For example, a method can be employed in which the two-dimensional region representing the capturing range of a tomographic image in a plane is divided into a two-dimensional equal grid. Then, the points in the representative point group are arranged at the intersections on the grid. Then, the weighted coefficient Wₛₙ of each point in the representative point group can be calculated based on a distance d_{q} between the point and the intersection Xₚ, and the distance dₚ between the plane and the position of the region of interest after deformation. In this case, for representative points for which d_{q}²+dₚ² is smaller than a predetermined threshold, the weighted coefficient Wₛₙ is increased, and for representative points for which d_{q}²+dₚ² is greater than or equal to the predetermined threshold, the weighted coefficient Wₛₙ is decreased. Accordingly, the weighted coefficient Wₛₙ given to each point in the representative point group differs depending on whether or not the position of the point is inside the sphere having a predetermined radius centered about the position of the region of interest after deformation. Note that the method for calculating the weighted coefficient Wₛₙ is not limited to this.

In step S6002, the corresponding point group calculation unit 1142 shifts the positions of the points in the representative point group calculated in step S6001 based on the displacement field T(x, y, z) calculated in step S602. Firstly, based on the displacement field T(x, y, z), a deformation that will occur when the body position changes from the supine position to the prone position, which is an inverse transformation of the displacement field T(x, y, z), is calculated as a displacement field (3D vector field) Tᵢₙᵥ(x, y, z) in the second reference coordinate system. Then, based on the Tᵢₙᵥ(x, y, z), calculation is performed to obtain the positions of the point group (corresponding point group) in the first 3D image that correspond to the positions of the points in the representative point group in the second 3D image. Specifically, for example, the positions X_{dn} (n=1 to N) of the corresponding point group in the first 3D image are calculated by adding the displacement fields Tᵢₙᵥ(xₛₙ, yₛₙ, zₛₙ) at the positions Xₛₙ of the representative point group to the positions Xₛₙ of the corresponding point group.

The processing of step S6003 is performed in a similar manner to that of step S3003 of the first embodiment, and thus is not described here.

This completes the description of the processing of step S606.

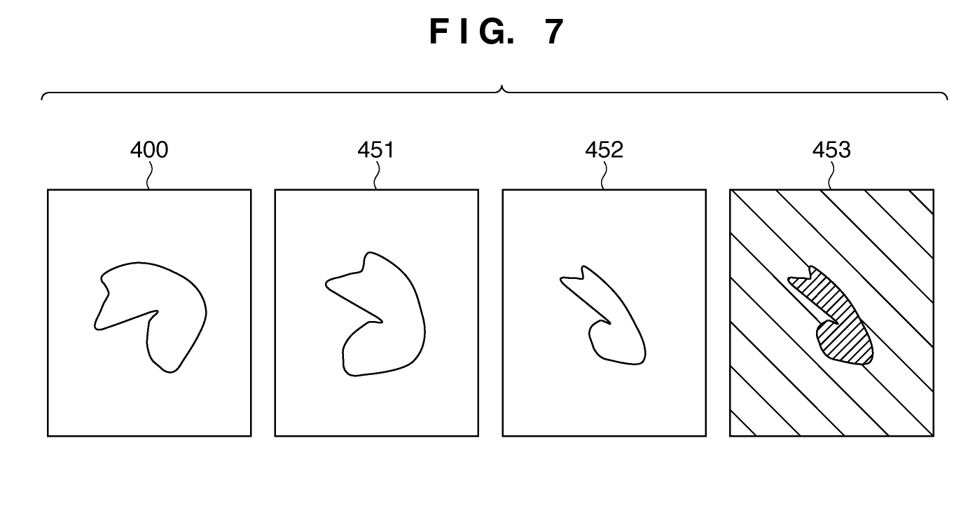

In step S607, the display image generating unit 515 generates a display image. The processing of this step is described below with reference to FIG. 7. Note that FIG. 7 displays a two-dimensional image, which is originally a 3D image.

Firstly, the display image generating unit 515 generates the third 3D image 451 by performing rigid transformation based on the relation calculated in step S606 on the first 3D image 400 obtained in step S601. Since a known method can be used for rigid transformation of 3D images, the method is not described here. This processing involves rigid transformation of a first 3D image such that the position and orientation of the region of interest in the third 3D image 451 substantially match those of the region of interest in the second 3D image 452.

Then, two-dimensional images (display images) for displaying the third 3D image and the second 3D image are generated. For example, a plane representing a tomographic image is obtained based on the position and orientation of a tomographic image 453, the reference coordinate systems for the third 3D image and the second 3D image are regarded as the same, and cross section images of the second and third 3D images taken along that plane are obtained. Lastly, the image processing apparatus 11 displays the display images generated as described above on the display unit 206.

Note that the processing in steps S605 and S606 is repeatedly performed according to sequentially input tomographic images.

This completes the description of the processing of the image processing apparatus 11.

As described above, in the case where the region of interest such as a lesion portion is included in (or near) cross section images, an image processing apparatus of the present embodiment performs display so as to align the orientation of the regions of interest in the images. Also, in the case where the region of interest is distant from the cross section images, display is performed so as to align the orientation of the cross section images as a whole. Accordingly, the cross sections of the region of interest such as a lesion portion before and after deformation can be easily compared, and also it becomes easier to grasp the overall relation between the shapes before and after deformation.

### Fourth Embodiment

In the third embodiment, in the processing of step S6003, the case is described as an example in which a rigid transformation that substantially matches the positions and orientations of the target object captured in a tomographic image and a 3D image with each other is calculated; however, the calculation method is not limited to the above-described method. For example, as the processing in the first stage, a plane on a 3D image that substantially matches a plane containing the cross section of a target object captured in a tomographic image is obtained. At this time, the obtained plane is free to rotate and be translated in the plane. Then, as the processing in the second stage, processing for obtaining rotation and translation in the plane may be additionally executed. That is, the processing for obtaining a rigid transformation of the present invention may include processing that obtains the rigid transformation in plural stages.

The present invention enables generation of corresponding cross section images in a plurality of 3D images.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-098127 filed on Apr. 21, 2010, which is hereby incorporated by reference herein in its entirety.

What is claimed is:

1. An image processing apparatus comprising:
a deformation unit adapted to deform a first 3D image to a second 3D image;
a calculation unit adapted to obtain a relation according to which rigid transformation is performed such that a region of interest in the first 3D image overlaps a region in the second 3D image that corresponds to the region of interest in the first 3D image; and
an obtaining unit adapted to obtain, based on the relation, a cross section image of the region of interest in the second 3D image and a cross section image of the region of interest in the first 3D image that corresponds to the orientation of the cross section image in the second 3D image.

2. The image processing apparatus according to claim 1,
wherein the deformation unit comprises:
an image obtaining unit adapted to obtain a first 3D image of a target object in a first position and orientation, captured by a capturing unit;
a shift calculation unit adapted to calculate a shift amount between a shape of the target object in the first position and orientation and a shape of the target object in a second position and orientation that are different from the first position and orientation, based on a difference in a relative direction of an external force applied to the target object; and
a first generating unit adapted to generate the second 3D image of the target object in the second position and orientation from the first 3D image, based on the shift amount.

3. The image processing apparatus according to claim 2,
wherein the calculation unit comprises:
a region obtaining unit adapted to obtain a characteristic region representing a region that is characteristic in the first 3D image;
a setting unit adapted to set a predetermined range based on the characteristic region as a peripheral region of the characteristic region;
a representative point group obtaining unit adapted to obtain positions of a plurality of representative points indicating the characteristic region in the first 3D image within the peripheral region as representative point group positions;
a weighted coefficient calculation unit adapted to calculate a weighted coefficient for each of the representative points;
a corresponding point group obtaining unit adapted to obtain corresponding point group positions in the second 3D image generated by the first generating unit, the corresponding point group positions corresponding to the representative point group positions, by shifting the representative point group positions based on the shift amount; and
a matrix calculation unit adapted to calculate a transformation matrix for transformation from the representative point group positions to the corresponding point group positions, based on the representative point group positions, the weighted coefficients, and the corresponding point group positions, and
the transformation matrix calculated by the matrix calculation unit is calculated as the relation according to which rigid transformation is performed.

4. The image processing apparatus according to claim 3, further comprising:
a second generating unit adapted to generate a third 3D image by performing transformation by the transformation matrix on the first 3D image; and
a cross section image obtaining unit adapted to obtain a cross section image in the second 3D image and a cross section image in the third 3D image that corresponds to the cross section image in the second 3D image.

5. The image processing apparatus according to claim 4, further comprising a display unit adapted to display the cross section image in the second 3D image obtained by the cross section image obtaining unit or the cross section image in the third 3D image that corresponds to the cross section image in the second 3D image.

6. The image processing apparatus according to claim 3,
wherein the matrix calculation unit obtains, for each of the representative points, a value by multiplying a norm of the difference between the corresponding point and a product of the transformation matrix and the representative point by the weighted coefficient, calculates a sum total of the obtained values, and calculates a transformation matrix that produces a smallest sum total.

7. The image processing apparatus according to claim 3,
wherein the weighted coefficient calculation unit calculates the weighted coefficient of each representative point such that the weighted coefficient of the representative point is larger as the distance thereto from a center of gravity of the characteristic region or a center of gravity of the peripheral region is shorter.

8. The image processing apparatus according to claim 3,
wherein the representative point group obtaining unit detects, for each three-dimensional element constituting the peripheral region, an edge intensity based on a pixel value of the three-dimensional element, and obtains a three-dimensional element having an edge intensity greater than or equal to a threshold as a position of a representative point.

9. The image processing apparatus according to claim 8,
wherein the weighted coefficient calculation unit calculates the weighted coefficient of each representative point such that the weighted coefficient is larger as the edge intensity is higher.

10. A method for processing an image comprising:
deforming a first 3D image into a second 3D image;
obtaining a relation according to which rigid transformation is performed such that a region of interest in the first 3D image overlaps a region in the second 3D image that corresponds to the region of interest in the first 3D image; and
obtaining, based on the relation, a cross section image of the region of interest in the second 3D image and a cross section image of the region of interest in the first 3D image that corresponds to the orientation of the cross section image in the second 3D image.

11. A computer-readable non-transitory storage medium storing a computer program for causing a computer to execute the method for processing an image according to claim 10.
